(19) United States
(12) Patent Application Publication
(10) Pub. No.: US 2023/0416109 A1
(43) Pub. Date: Dec. 28, 2023

(54) MOLYBDENUM TRIOXIDE WITH NOVEL MOLECULAR STRUCTURE AND CHIRAL OCTAHEDRAL CRYSTAL PHASE STRUCTURE, OCTAMOLYBDATE OF MOLYBDENUM TRIOXIDE AND PREPARATION METHOD OF OCTAMOLYBDATE

(71) Applicant: HUBEI ZHONG'AO NANOTECH CO., LTD, Guangshui (CN)

(72) Inventors: Fangwu CHEN, Guangshui (CN); Luocheng CHEN, Guangshui (CN); Xu ZHAO, Guangshui (CN); Qicheng LI, Guangshui (CN); Zhen CHEN, Guangshui (CN); Yiqing YU, Guangshui (CN); Xinyun YAO, Guangshui (CN); Zikang ZHAI, Guangshui (CN)

(21) Appl. No.: 18/299,084

(22) Filed: Sep. 4, 2023

(30) Foreign Application Priority Data
Apr. 12, 2022 (CN) 202210379125.4

(51) Int. Cl. C01G 39/02

(52) U.S. Cl. CPC C01G 39/02

(57) ABSTRACT

Disclosed are molybdenum trioxide with a novel molecular structure and a chiral octahedral crystal phase structure, octamolybdate of the molybdenum trioxide and a preparation method of the octamolybdate. A molecular formula of α-MoO₃ with the novel molecular structure and the chiral octahedral crystal phase structure is Mo₈O₂₄, and the generated nano-molybdate based on the octamolybdate is a new species, so that a new member is added to inorganic salt chemical industry, and an application of the nano-molybdate changes all aspects of daily life of people, for example, the nano-molybdate having a disinfection function and insoluble in water is used in agricultural crop production and quality improvement, freshwater aquaculture and mariculture, sanitary disinfection, various anti-microbial and anti-tumor activities, batteries and various energy storages, semi-conductors, anti-biochemical weapons, intelligent materials and other aspects.

### CROSS REFERENCE TO RELATED APPLICATIONS

This application claims foreign priority of Chinese Patent Application No. 202210379125.4, filed on Apr. 12, 2022 in the China National Intellectual Property Administration, the disclosures of all of which are hereby incorporated by reference.

### TECHNICAL FIELD

The present invention relates to the technical field of molybdenum oxide and molybdate, and particularly to α-MoO₃ with a novel molecular structure and a chiral octahedral crystal phase structure, octamolybdate of the α-MoO₃ and a preparation method of the octamolybdate.

### BACKGROUND OF THE PRESENT INVENTION

In the molybdenum chemical industry and the basic knowledge theory of molybdenum chemical industry, molybdenum trioxide is divided into normal molybdenum trioxide, dimolybdenum trioxide, tetramolybdenum trioxide, heptamolybdatetrioxide and the like, such as normal ammonium molybdate, ammonium dimolybdate, ammonium tetramolybdate and ammonium heptamolybdate.

In the practical application of molybdenum industrial products, ordinary molybdenum trioxide (or molybdic acid) is used to prepare various molybdate products. In order to make the products have more superior physical and chemical characteristics, the products must undergo secondary crystallization to be converted into an α-MoO₃ crystal structure by methods comprising a thermal decomposition method, a hydrothermal method, a sol-gel method, a template method and the like. A specific principle is to convert the products at a temperature of 160° C. to 180° C. under a pressure of 10 standard atmospheres for about 48 hours, or by a method of controlling a coordination mode and a coordination intensity of water molecules and MoO_{X} with NO₃⁻ (or other acid radicals), so that there are many unfavorable factors, such as strict equipment requirements, much waste water and long time, and industrial production cannot be realized.

Therefore, we propose α-MoO₃ with a novel molecular structure and a chiral octahedral crystal phase structure, octamolybdate of the α-MoO₃ and a preparation method of the octamolybdate.

### SUMMARY OF PRESENT INVENTION

In order to overcome the defects in the prior art, the present invention provides α-MoO₃ with a novel molecular structure and a chiral octahedral crystal phase structure, octamolybdate of the α-MoO₃ and a preparation method of the octamolybdate.

In order to achieve the above object, the present invention provides the following technical solution: a molecular formula of the α-MoO₃ with the novel molecular structure and the chiral octahedral crystal phase structure is Mo₈O₂₄, and a molecular structure model of the α-MoO₃ is shown in FIG. 1, in the model, a big ball is a molybdenum atom and a small ball is an oxygen atom.

Preferably, the octamolybdate is prepared from the α-MoO₃ with the chiral octahedral crystal phase structure.

Preferably, a general formula of the soluble octamolybdate generated by a reaction of the α-MoO₃ with the chiral octahedral crystal phase structure and a monovalent cation is: MeₓMo₈O₍₂₄₊ₐₓ₎, in the formula, Me is an elemental ion or an ion radical,
in the formula, x=10, 12, 14, 16, 18; and
a=1.

Preferably, a general formula of the octamolybdate generated by a reaction of the α-MoO₃ with the chiral octahedral crystal phase structure and a bivalent cation is: MeₓMo₈O₍₂₄₊ₐₓ₎,
in the formula, x=5, 6, 7, 8, 9; and
a=1.

Preferably, a general formula of the octamolybdate generated by a reaction of the α-MoO₃ with the chiral octahedral crystal phase structure and a trivalent cation is: MeₓMo₈O₍₂₄₊ₐₓ₎,
in the formula, x=10, 12, 14, 16, 18 or 20, 24, 28, 32, 36; and
a=1.5.

Preferably, a general formula of the octamolybdate generated by a reaction of the molybdenum trioxide with the chiral octahedral crystal phase structure and a tetravalent cation is: MeₓMo₈O₍₂₄₊ₐₓ₎,
in the formula, x=5, 6, 7, 8, 9; and
a=2.

Preferably, a general formula of the octamolybdate generated by a reaction of the molybdenum trioxide with the chiral octahedral crystal phase structure and a pentavalent cation is: MeₓMo₈O₍₂₄₊ₐₓ₎,
in the formula, x=10, 12, 14, 16, 18 or 20, 24, 28, 32, 36; and
a=2.5.

Preferably, a general formula of the octamolybdate generated by a reaction of the molybdenum trioxide with the chiral octahedral crystal phase structure and a sexivalent cation is: MeₓMo₈O₍₂₄₊ₐₓ₎,
in the formula, x=5, 6, 7, 8, 9; and
a=3.

Preferably, a general formula of the octamolybdate generated by a reaction of the molybdenum trioxide with the chiral octahedral crystal phase structure and a septivalent cation is: MeₓMo₈O₍₂₄₊ₐₓ₎,
in the formula, x=10, 12, 14, 16, 18; and
a=3.5.

Preferably, according to a preparation method of the octamolybdate prepared from the α-MoO₃ with the chiral octahedral crystal phase structure, when the cation is a soluble compound (or produces a soluble compound), the preparation method comprises the following steps of:
I: putting deionized water added with a dispersant into a reaction kettle with ultrasonic and electric heating functions, and starting the ultrasonic and electric heating functions; specifically, adding a set amount of deionized water into the reaction kettle, and then adding the dispersant according to a ratio of 10 mg/L; the reaction kettle having stirring and ultrasonic functions, respectively starting the ultrasonic and stirring functions in turn, and a time ratio of ultrasonic processing to stirring being 30:1;
II: 2 hours later, adding the α-MoO₃ at a water temperature of about 60° C. to 70° C.;
III: half an hour after adding the α-MoO₃, adding a cationic reactant, wherein the cationic reactant is one or a combination of hydrates or oxides and carbonates of ammonium, an alkali metal and a transition element; and a molar ratio is that Me:α-MoO₃=x:8; and
IV: after the reaction, continuing the ultrasonic processing for 1 hour to 2 hours to obtain a hydrolyzed nano-molybdate product.

Preferably, according to a preparation method of the octamolybdate prepared from the α-MoO₃ with the chiral octahedral crystal phase structure, when the cation is an insoluble compound, the preparation method comprises the following steps of:
I: fully mixing a water-insoluble cationic oxide or carbonate with the α-MoO₃ according to a ratio, wherein when the cation Me is 1+, a mixed molar ratio is that Me:α-MoO₃=x:8,
in the formula, X=5, 6, 7, 8, 9 or 10, 12, 14, 16, 18 or 20, 24, 28, 32, 36;
II: adding the above mixture into a multi-stage electric heating converter, wherein a highest converter temperature is no higher than 470° C., and a standing time in the electric heating converter is 100 minutes to 120 minutes; and the highest temperature appears at a two third place from the front to the rear of the electric heating converter, and the highest temperature at the place is 470° C.; and
III: adding 0.8% to 1% of dispersant according to a weight ratio, and then putting the mixture into a resonance mixer for full stirring to obtain a powder nano-molybdate product after mixing.

Preferably, according to a preparation method of the octamolybdate prepared from the molybdenum trioxide with the chiral octahedral crystal phase structure, when the cation is an insoluble compound, the preparation method comprises the following steps of:
I: fully mixing a water-insoluble cationic oxide or carbonate with the α-MoO₃ according to a ratio, wherein a mixed molar ratio is that Me:α-MoO₃=x:8,
in the formula, X=5, 6, 7, 8, 9 or 10, 12, 14, 16, 18 or 20, 24, 28, 32, 36;
II: adding the above mixture into a multi-stage electric heating converter, wherein a highest converter temperature is no higher than 470° C., and a standing time in the electric heating converter is 100 minutes to 120 minutes; and the highest temperature appears at a two third place from the front to the rear of the electric heating converter, and the highest temperature at the place is 470° C.; and
III: putting deionized water added with a dispersant into a reaction kettle with ultrasonic and electric heating functions, and starting the ultrasonic and electric heating functions; specifically, adding a set amount of deionized water into the reaction kettle, and then adding the dispersant according to a ratio of 10 mg/L; the reaction kettle having stirring and ultrasonic functions, respectively starting the ultrasonic and stirring functions in turn, and a time ratio of ultrasonic processing to stirring being 30:1;
IV: 2 hours later, adding the mixture obtained in the step II at a water temperature of about 60° C. to 70° C.; and
V: carrying out ultrasonic processing for 1 hour to 2 hours to obtain a hydrolyzed nano-molybdate product.

Compared with the prior art, the molybdenum trioxide with the novel molecular structure and the chiral octahedral crystal phase structure, the octamolybdate of the molybdenum trioxide and the preparation method of the octamolybdate provided by the present invention have the following beneficial effects:
in the present invention, the generated nano-molybdate based on the octamolybdate is a new species, so that a new member is added to inorganic salt chemical industry, and an application of the nano-molybdate changes all aspects of daily life of people, for example, the nano-molybdate having a disinfection function and insoluble in water is used in agricultural crop production and quality improvement, freshwater aquaculture and mariculture, sanitary disinfection, various anti-microbial and anti-tumor activities, batteries and various energy storages, semi-conductors, anti-biochemical weapons, intelligent materials and other aspects. Due to insolubility in water, the molybdenum trioxide is not easy to lose, can last for a long time, and a validity period of the molybdenum trioxide is calculated in years, and is easy to realize infinite green recycling in some aspects. The preparation method of the octamolybdate is simple and efficient.

### DESCRIPTION OF THE DRAWINGS

The drawings are provided to further understand the present invention and constitute a part of the specification. The drawings are used together with embodiments of the present invention to explain the present invention, but are not intended to limit the present invention. In the drawings:

FIG. 1 is a model map of a molecular structure of molybdenum trioxide with a chiral octahedral crystal phase structure according to the present invention;

FIG. 2 is a schematic diagram of a first preparation method of octamolybdate prepared from the molybdenum trioxide with the chiral octahedral crystal phase structure according to the present invention; and

FIG. 3 is a schematic diagram of a second preparation method of the octamolybdate prepared from the molybdenum trioxide with the chiral octahedral crystal phase structure according to the present invention.

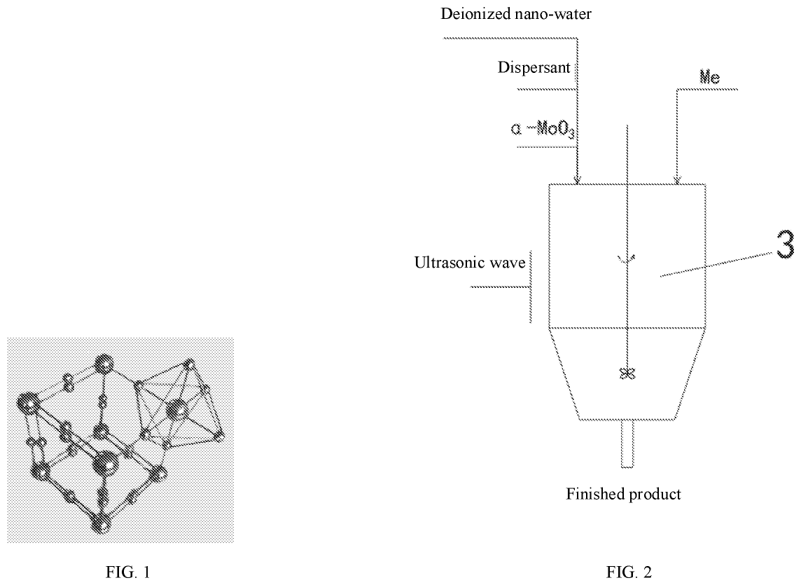

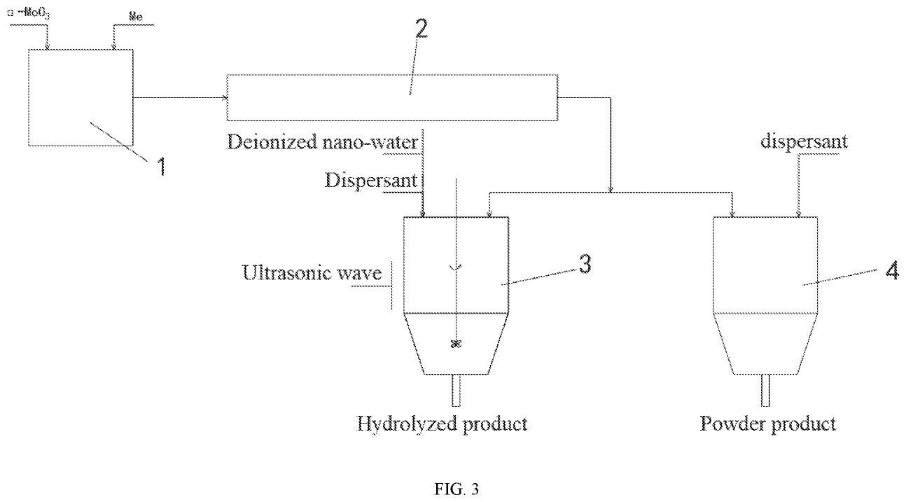

In FIG. 1, big ball refers to molybdenum atom and small ball refers to oxygen atom; in FIG. 2, 3 refers to reaction kettle; and in FIG. 3, 1 refers to efficient mixer; 2 refers to multi-stage electric heating converter; 3 refers to reaction kettle; and 4 refers to resonance mixer.

### DETAILED DESCRIPTION OF PREFERRED EMBODIMENTS

The technical solution in embodiments of the present invention will be described clearly and completely hereinafter with reference to the drawings in the embodiments of the present invention. Apparently, the embodiments described are merely some but not all of the embodiments of the present invention. Based on the embodiments of the present invention, all other embodiments obtained by those of ordinary skills in the art without going through any creative work belong to the scope of protection of the present invention.

With reference to FIG. 1, the present invention provides a technical solution that: a molecular formula of α-MoO₃ with a novel molecular structure and a chiral octahedral crystal phase structure is Mo₈O₂₄, and a molecular structure model of the α-MoO₃ is shown in FIG. 1, in the model, a big ball is a molybdenum atom and a small ball is an oxygen atom.

The molybdenum trioxide with the chiral octahedral crystal phase structure, which is namely the α-MoO₃, has a heteromorphic chiral octahedral crystal phase, the molecular formula of Mo₈O₂₄, and a structural body of MoO₆ contained in molecules, and may also be understood as a molybdenum trioxide quantum unit α-MoO₃, and molybdate α-MeMoO₄ synthesized from the molybdenum trioxide also has the same physical and chemical characteristics.

Researches and experiments show that the α-MoO₃ has the most stable crystal phase structure, and other molybdenum trioxide has a metastable phase structure, wherein the molybdenum trioxide with the metastable phase may be converted into an α-MoO₃ crystal structure through secondary crystallization by a certain physical and chemical method. However, the α-MoO₃ and α-WO₃ studied so far are very rare, and are often only studied and expressed in a certain field.

High-purity nano-molybdenum trioxide invented and produced by Hubei Zhong'ao Nanomaterials Technology Co., Ltd. adopts a process of “sublimation—air quenching”; and a crystal phase of the high-purity nano-molybdenum trioxide is an α-MoO₃ structure, industrial scale production of the high-purity nano-molybdenum trioxide has been realized, and the high-purity nano-molybdenum trioxide may be prepared into spherical (zero-dimensional) high-purity nano-molybdenum trioxide with a particle size of 30 nm.

Various octamolybdates (or nano-scales) are prepared from the α-MoO₃ as a raw material, an ionic formula of an octamolybdic acid radical of the α-MoO₃ is [Mo₈O₍₂₄₊ₐₓ₎]^{y-}, with a total of five valences comprising 10-, 12-, 14-, 16- and 18-. The α-MoO₃ may be called the octamolybdic acid radical, which constitutes the most basic “quantum” unit of various octomolybdates.

A general formula of octamolybdate generated by a reaction of a monovalent cation and the α-MoO₃ is: MeₓMo₈O₍₂₄₊ₐₓ₎,
such as: K₁₈Mo₈O₃₃ and (NH₄)₁₈Mo₈O₃₃.

A general formula of octamolybdate generated by a reaction of a bivalent cation and the α-MoO₃ is: MeₓMo₈O₍₂₄₊ₐₓ₎,
such as: Zn₇Mo₈O₃₁ and Zn₉Mo₈O₃₃.

A general formula of octamolybdate generated by a reaction of a trivalent cation and the α-MoO₃ is: MeₓMo₈O₍₂₄₊ₐₓ₎,
such as: Bi₆Mo₈O₃₃ and Fe₆Mo₈O₃₃; and Bi₁₈Mo₈O₅₁.

A general formula of octamolybdate generated by a reaction of a tetravalent cation and the α-MoO₃ is: MeₓMo₈O₍₂₄₊ₐₓ₎,
such as: Mn9Mo₈O₄₂; and Mn₅Mo₈O₃₄.

As shown in FIG. 2, according to a preparation method of the octamolybdate prepared from the molybdenum trioxide with the chiral octahedral crystal phase structure, when the cation is a soluble compound, the preparation method comprises the following steps.
1. Deionized water added with a dispersant is added into a reaction kettle 3 with ultrasonic and electric heating functions, and the ultrasonic and electric heating functions are started; specifically, a set amount of deionized water is added into the reaction kettle 3, and then the dispersant is added according to a ratio of 10 mg/L; and the reaction kettle 3 has stirring and ultrasonic functions, the ultrasonic and stirring functions are respectively started in turn, and a time ratio of ultrasonic processing to stirring is 30:1.
2. 2 hours later, the nano-trioxide α-MoO₃ is added at a water temperature of about 60° C. to 70° C.
3. Half an hour after adding the α-MoO₃, a cationic reactant is added, wherein the cationic reactant is one or a combination of hydrates or oxides and carbonates of ammonium, an alkali metal and various transition elements; and a molar ratio is that Me:α-MoO₃=18:8, such as K₁₈Mo₈O₃₃.
4. After the reaction, the ultrasonic processing is continued for 1 hour to 2 hours to obtain a hydrolyzed nano-molybdate product.

As shown in FIG. 3, according to a preparation method of the octamolybdate prepared from the α-MoO₃ with the chiral octahedral crystal phase structure, when the cation is an insoluble compound, such as an oxide and a carbonate, the preparation method comprises the following steps.
1. A water-insoluble cationic oxide or carbonate is fully mixed with the α-MoO₃ according to a ratio in an efficient mixer 1, and then the mixture is slowly added into a multi-stage electric heating converter 2.
2. A highest converter temperature of the multi-stage electric heating converter 2 is no higher than 470° C., and a standing time in the multi-stage electric heating converter 2 is 100 minutes to 120 minutes; and the highest temperature appears at a two third place from the front to the rear of the multi-stage electric heating converter 2, and the highest temperature at the place is 470° C.
2-1. If a powder product is needed, 0.8% to 1% of dispersant is added into the reactant in the step 2 according to a weight ratio, and then the mixture is put into a resonance mixer 4 for full stirring to obtain a powder nano-molybdate product after mixing.
2-2. If a hydrolyzed product is needed, the reactant in the step 2 is processed by the method shown in FIG. 2 to obtain a hydrolyzed nano-molybdate product.

The synthetic reactions in FIG. 2 and FIG. 3 may both be carried out by a dry method shown in FIG. 3, but if one of the reactant and the product is a soluble substance, the production may be carried out by a wet method shown in FIG. 2, with a lower production cost.

A powder product prepared from hydrolyzed α-MeMoO₄ may be implemented by various drying processes, wherein a freeze-drying process is strictly prohibited, especially for a nano-molybdate finished product.

A controllable particle size of the octamolybdate prepared by the present invention may be less than 10 nm, and a particle size of various α-MeMoO₄ molybdates is less than 100 nm.

Compared with the prior art, the present invention has the following beneficial effects:
in the present invention, the generated nano-molybdate based on the octamolybdate is a new species, so that a new member is added to inorganic salt chemical industry, and an application of the nano-molybdate changes all aspects of daily life of people, for example, the nano-molybdate having a disinfection function and insoluble in water is used in agricultural crop production and quality improvement, freshwater aquaculture and mariculture, sanitary disinfection, various anti-microbial and anti-tumor activities, batteries and various energy storages, semi-conductors, anti-biochemical weapons, intelligent materials and other aspects. Due to insolubility in water, the molybdenum trioxide is not easy to lose, can last for a long time, and a validity period of the molybdenum trioxide is calculated in years, and is easy to realize infinite green recycling in some aspects. The preparation method of the octamolybdate is simple and efficient.

The above embodiments are only used to explain the technical concepts and features of the present invention, and are intended to enable those skilled in the art to understand and implement the contents of the present invention, without limiting the scope of protection of the present invention. All equivalent changes or modifications made according to the spirit of the present invention should be included in the scope of protection of the present invention.

1. Molybdenum trioxide with a novel molecular structure and a chiral octahedral crystal phase structure, wherein a molecular formula of the molybdenum trioxide is Mo₈O₂₄, which is α-MoO₃.

2. Octamolybdate prepared from the molybdenum trioxide with the novel molecular structure and the chiral octahedral crystal phase structure according to claim 1, wherein the octamolybdate is prepared from the molybdenum trioxide (hereinafter referred to as α-MoO₃) with the chiral octahedral crystal phase structure as a raw material.

3. The octamolybdate prepared from the α-MoO₃ with the novel molecular structure and the chiral octahedral crystal phase structure according to claim 2, wherein a general formula of the octamolybdate generated by a reaction of the α-MoO₃ with the chiral octahedral crystal phase structure and a monovalent cation is: MeₓMo₈O₍₂₄₊ₐₓ₎,
in the formula, Me is an elemental cation or a compound with a cationic characteristic; and ax is a coefficient;
a molecular formula of soluble nano-molybdate as a product is Me₁₈Mo₈O₃₃,
a molecular formula of insoluble nano-molybdate as a product is MeₓMo₈O_{(24+a x)},
in the formula, x=10, 12, 14, 16, 18; and
a=0.5.

4. The octamolybdate prepared from the α-MoO₃ with the novel molecular structure and the chiral octahedral crystal phase structure according to claim 2, wherein a general formula of the octamolybdate generated by a reaction of the α-MoO₃ with the chiral octahedral crystal phase structure and a bivalent cation is: MeₓMo₈O₍₂₄₊ₐₓ₎,
in the formula, x=5, 6, 7, 8, 9; and
a=1.

5. The octamolybdate prepared from the α-MoO₃ with the novel molecular structure and the chiral octahedral crystal phase structure according to claim 2, wherein a general formula of the octamolybdate generated by a reaction of the α-MoO₃ with the chiral octahedral crystal phase structure and a trivalent cation is: MeₓMo₈O₍₂₄₊ₐₓ₎,
in the formula, x=10, 12, 14, 16, 18 or 20, 24, 28, 32, 36; and
a=1.5.

6. The octamolybdate prepared from the α-MoO₃ with the novel molecular structure and the chiral octahedral crystal phase structure according to claim 2, wherein a general formula of the octamolybdate generated by a reaction of the α-MoO₃ with the chiral octahedral crystal phase structure and a tetravalent cation is: MeₓMoO₍₂₄₊ₐₓ₎,
in the formula, x=5, 6, 7, 8, 9; and
a=2.

7. The octamolybdate prepared from the α-MoO₃ with the novel molecular structure and the chiral octahedral crystal phase structure according to claim 2, wherein a general formula of the octamolybdate generated by a reaction of the α-MoO₃ with the chiral octahedral crystal phase structure and a pentavalent cation is: MeₓMo₈O₍₂₄₊ₐₓ₎,
in the formula, x=10, 12, 14, 16, 18 or 20, 24, 28, 32, 36; and
a=2.5.

8. The octamolybdate prepared from the α-MoO₃ with the novel molecular structure and the chiral octahedral crystal phase structure according to claim 2, wherein a general formula of the octamolybdate generated by a reaction of the α-MoO₃ with the chiral octahedral crystal phase structure and a sexivalent cation is: MeₓMo₈ O₍₂₄₊ₐₓ₎,
in the formula, x=5, 6, 7, 8, 9; and
a=3.

9. The octamolybdate prepared from the α-MoO₃ with the novel molecular structure and the chiral octahedral crystal phase structure according to claim 2, wherein a general formula of the octamolybdate generated by a reaction of the α-MoO₃ with the chiral octahedral crystal phase structure and a septivalent cation is: MeₓMo₈ O₍₂₄₊ₐₓ₎,
in the formula, x=10, 12, 14, 16, 18; and
a=3.5.

10. A preparation method of the octamolybdate prepared from the α-MoO₃ with the chiral octahedral crystal phase structure according to claim 2, wherein when the cation is a soluble (or hydrolysable) compound, the preparation method comprises the following steps of:
I: putting deionized water added with a dispersant into a reaction kettle with ultrasonic and electric heating functions, and starting the ultrasonic and electric heating functions; specifically, adding a set amount of deionized water into the reaction kettle, and then adding the dispersant according to a ratio of 10 mg/L; the reaction kettle having stirring and ultrasonic functions, respectively starting the ultrasonic and stirring functions in turn, and a time ratio of ultrasonic processing to stirring being 30:1;
II: 2 hours later, adding the α-MoO₃ at a water temperature of about 60° C. to 70° C.;
III: half an hour after adding the α-MoO₃, adding a cationic reactant, wherein the cationic reactant is one or a combination of hydrates or oxides and carbonates of ammonium, an alkali metal, a transition element and the like; and
IV: after the reaction, continuing the ultrasonic processing for 1 hour to 2 hours to obtain a water-soluble nano-molybdate product.

11. A preparation method of the octamolybdate prepared from the nano-molybdenum trioxide (α-MoO₃) with the chiral octahedral crystal phase structure according to claim 2, wherein when the cation is an insoluble compound, the preparation method comprises the following steps of:
I: fully mixing a water-insoluble cationic oxide or carbonate with the α-MoO₃ according to a ratio, wherein a mixed molar ratio is that Me:α-MoO₃=x:8;
II: adding the above mixture into a multi-stage electric heating converter, wherein a highest converter temperature is no higher than 470° C., and a standing time in the electric heating converter is 100 minutes to 120 minutes; and the highest temperature appears at a two third place from the front to the rear of the electric heating converter, and the highest temperature at the place is 470° C.; and
III: adding 0.8% to 1% of dispersant according to a weight ratio, and then putting the mixture into a resonance mixer for full stirring to obtain a powder nano-molybdate product after mixing.

12. A preparation method of the octamolybdate prepared from the α-MoO₃ with the chiral octahedral crystal phase structure according to claim 2, wherein when the cation is an insoluble compound, the preparation method comprises the following steps of:
I: fully mixing a water-insoluble cationic oxide or carbonate with the α-MoO₃ according to a ratio, wherein a mixed molar ratio is that Me:α-MoO₃=x:8;
II: adding the above mixture into a multi-stage electric heating converter, wherein a highest converter temperature is no higher than 470° C., and a standing time in the electric heating converter is 100 minutes to 120 minutes; and the highest temperature appears at a two third place from the front to the rear of the electric heating converter, and the highest temperature at the place is 470° C.; and
III: putting deionized water added with a dispersant into a reaction kettle with ultrasonic and electric heating functions, and starting the ultrasonic and electric heating functions; specifically, adding a set amount of deionized water into the reaction kettle, and then adding the dispersant according to a ratio of 10 mg/L; the reaction kettle having stirring and ultrasonic functions, respectively starting the ultrasonic and stirring functions in turn, and a time ratio of ultrasonic processing to stirring being 30:1;
IV: 2 hours later, adding the mixture obtained in the step II at a water temperature of about 60° C. to 70° C.; and
V: obtaining a hydrolytic nanomolybdate product after ultrasonic treatment for 1-2 hours.
